(19) United States
(12) Patent Application Publication
(10) Pub. No.: US 2006/0138760 A1
(43) Pub. Date: Jun. 29, 2006

(54) Airbag with gas distribution pipe

(75) Inventor: Jin-soo Jang, Shiga (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/312,358

(22) Filed: Dec. 21, 2005

Related U.S. Application Data
(60) Provisional application No. 60/639,324, filed on Dec. 28, 2004.
(60) Provisional application No. 60/643,600, filed on Jan. 14, 2005.

(51) Int. Cl. B60R 21/26

(52) U.S. Cl. 280/742; 280/740; 280/730.2

(57) ABSTRACT

A gas distribution pipe for balanced inflation and deployment of a side curtain airbag. The pipe has an end gas discharge opening and side gas discharge openings. The side discharge openings are configured to deflect the exiting gas so that at least a portion of the gas flows backwards along the outside of the pipe before entering the adjacent chamber of the airbag. An end cap for the pipe may contain both the end discharge opening and gas diverting and deflecting elements that direct gas to and through the side discharge openings.

### CROSS-REFERENCE TO RELATED APPLICATIONS

This application claims the benefit of and priority to the following U.S. Provisional Patent Applications:
Ser. No. 60/639,324, filed Dec. 28, 2004; and
Ser. No. 60/643,600, filed Jan. 14, 2005.

### BACKGROUND

The application relates to a side curtain airbag apparatus for a motor vehicle and, in particular, to an airbag including a gas distribution pipe or tube for delivering inflation gas to the airbag.

Side curtain airbags typically are housed along the vehicle roof rails and deploy extremely rapidly in an emergency situation to provide side cushioning for the outboard vehicle occupants. FIG. 1 illustrates a typical known side curtain airbag arrangement. In the example shown, the airbag 1 is divided into a first chamber 3 and a last chamber 4, which are designed to inflate adjacent the occupant seating positions. Other examples may include intermediate chambers, such as for vehicles having three rows of seats. These chambers have been formed by stitching along sewing lines 2, which can individually form circular sewing lines 50 at respective inlets of the chambers. The circular sewing lines 50 serve to avoid the concentration of stress when the airbag 1 is inflated.

Pressurized inflation gas is provided by an inflator mounted in the vehicle A-pillar, in the vehicle C-pillar, in the D-pillar, if so equipped, or in the roof rail between pillars. The inflator is connected to one end of a metallic gas distribution pipe or tube that extends into the airbag. Upon activation, the gas from the inflator flows through the distribution pipe 5, which is schematically illustrated in dashed lines in FIG. 1, into first chamber 3 through gap 54 and into last chamber 4 through channel 52.

An exemplary gas distribution pipe is disclosed in U.S. Pat. No. 6,164,688, which is incorporated herein by reference. This type of gas distribution pipe has spaced gas discharge openings along its long body, which are formed by inwardly deformed portions of the tube where incisions have been made, creating indentations that guide gas out of the pipe and into the adjacent airbag chambers. The angle of the indentations is such as to direct the gas obliquely out of the pipe, i.e., at a forward acute angle. Another example, U.S. Pat. No. 6,394,488, which also is incorporated herein by reference, discloses other forms of indentations at the gas discharge openings that direct gas in a similar manner.

### SUMMARY

According to an embodiment of the present invention, a safety system, device and/or airbag arrangement is provided so that airbag deployment may be balanced so that all of the airbag chambers fill with inflation gas in substantially the same amount of time. According to an embodiment, the balanced deployment is accomplished by deflecting the gas exiting the side discharge openings of the inflator such that at least a portion of the gas flows generally backwards along the outside of the pipe as it enters the adjacent chamber of the airbag. The deflecting arrangement may take many forms, and effectively creates a flow-directing nozzle that yields a backward gas velocity component.

Preferably, a portion of the gas is physically divided from the main axial flow in the pipe and is diverted toward the side discharge openings. The flow dividing and diverting arrangement may take many forms, all of which increase the rate of flow through the side discharge openings. Further, instead of discharging gas only along one side of the pipe, gas optionally can be discharged in multiple directions through a plurality of circumferentially spaced side discharge openings located at a particular lengthwise position on the pipe.

According to another embodiment, a side curtain airbag gas distribution pipe having an end discharge opening and at least one side discharge opening is provided. The side discharge opening may have associated therewith a deflector that directs at least a portion of the gas exiting the side discharge opening generally backwards along the outside of the pipe. The pipe, optionally, may have a plurality of circumferentially spaced side discharge openings at one lengthwise position on the pipe. For example, there may be two diametrically opposed side discharge openings.

In addition to any of the above arrangements, the gas distribution pipe may also have an internal flow divider associated with the side discharge opening that divides a portion of the gas from the main axial flow and diverts it toward the side discharge opening. In the case of multiple circumferentially spaced side discharge openings at one lengthwise position, the flow divider diverts gas to all of the openings at that lengthwise position.

The flow divider may be part of an end cap for the pipe. In that case, the end discharge opening is formed in the end cap and the flow divider extends into the pipe up to the lengthwise position of the side discharge opening(s).

According to another aspect, the invention involves a method of deploying a side curtain airbag by introducing inflation gas into one airbag chamber through a discharge opening at the end of a gas distribution pipe, and introducing inflation gas to an upstream airbag chamber through at least one side discharge opening such that at least a portion of the gas that emerges from the side discharge opening flows generally backwards along the outside of the pipe as it enters the upstream airbag chamber. The gas flow into the upstream airbag chamber preferably occurs through two side discharge openings.

It is to be understood that both the foregoing general description and the following detailed description are exemplary and explanatory only, and are not restrictive of the invention.

### BRIEF DESCRIPTION OF THE DRAWINGS

The aspects, and advantages of the present invention will become apparent from the following detailed description of the exemplary embodiments shown in the drawings, which are not necessarily drawn to scale. The drawing figures are briefly described below.

FIG. 1 is a side elevational view of a known side curtain airbag.

FIG. 2 is a bottom plan view of a portion of a gas distribution pipe for a side curtain airbag.

FIG. 3 is a longitudinal sectional view of the gas distribution pipe of FIG. 2, taken along line 3-3.

FIG. 4 is a plan view of a portion of a gas distribution pipe according to the invention.

FIG. 5 is a longitudinal sectional view of the gas distribution pipe of FIG. 4, taken along line 5-5, showing one embodiment of the invention.

FIG. 6 is a longitudinal sectional view similar to FIG. 5, taken along line 6-6, showing another embodiment of the invention.

FIG. 6(a) is a cross-sectional view of FIG. 6, taken along line 7-7.

FIG. 7 is a side elevational view of a side curtain airbag with a gas distribution pipe according to the invention that introduces inflation gas at a point intermediate the length of the airbag.

### DESCRIPTION

A gas distribution pipe for an airbag is shown in FIGS. 2 and 3, which depict a type of shorter and simpler gas distribution pipe 5. The distal end of the pipe has an end discharge opening 6 through which gas exits axially (i.e., lengthwise of the pipe, as indicated by arrow 6a) toward and into the last chamber 4. Closely spaced side discharge openings 7 discharge gas into the first chamber 3 in a radial, generally downward direction (as indicated by arrows 7a). All discharge openings are in the form of simple holes.

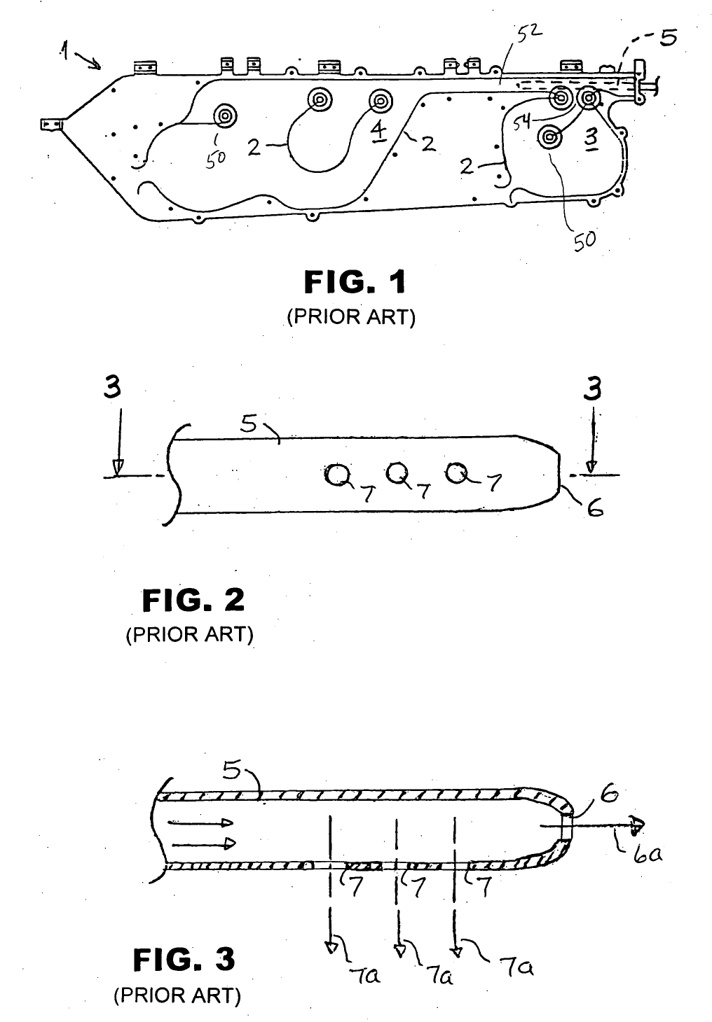

Gas distribution pipes may be used in arrangements similar to those shown in FIG. 1. For example, an alternate arrangement in which a short gas discharge pipe enters a side curtain airbag downwardly at a point intermediate the length of the airbag may be employed. The distal end of the pipe is tapered and blind, with two diametrically opposed holes that discharge inflation gas generally fore and aft. U.S. Pat. No. 6,808,203 discloses a gas distribution pipe and is incorporated by reference herein.

Preferably, the deployment of a side curtain airbag is balanced such that all protective portions (chambers) of the airbag fill with gas uniformly, i.e., in substantially the same amount of time, so as to afford maximum protection for all outboard vehicle occupants simultaneously. In the past, it has been observed that one chamber of the airbag usually deploys faster than the other chamber. A need therefore exists for a gas distribution pipe for a side curtain airbag that can be relied on to distribute inflation gas in such a way that airbag deployment is balanced.

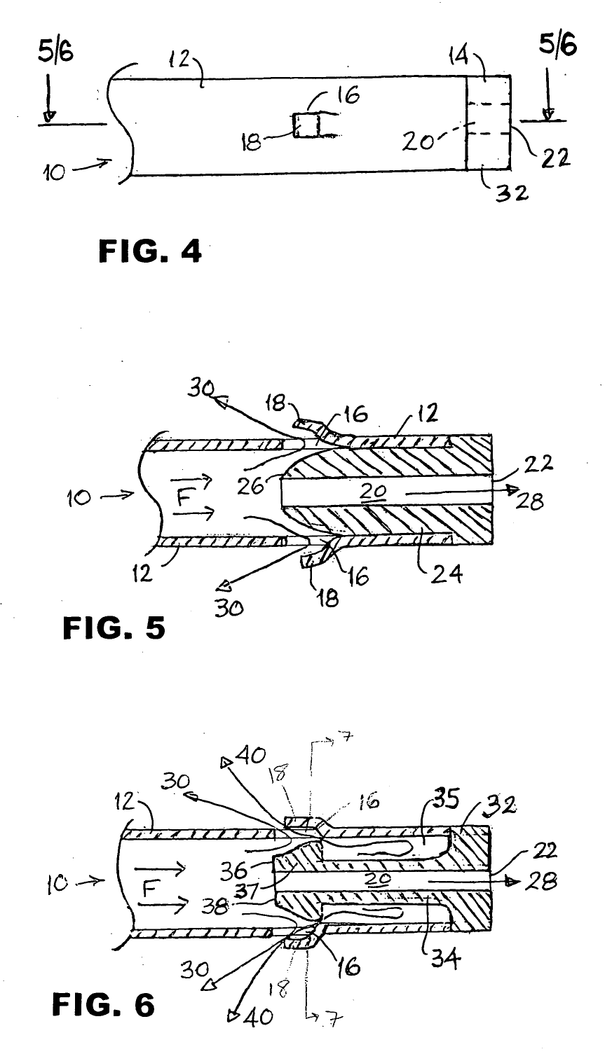

FIGS. 4 and 5 depict a gas distribution pipe 10 according to an embodiment of the invention. Pipe 10 has a metallic body 12, and an end cap 14 at the distal end of the pipe, which is secured to the body by any suitable means that is substantially gas-tight and will withstand the gas pressure within the pipe, such as by welding, brazing, or adhesive. An inflator (not shown), when activated, delivers inflation gas to the pipe, which flows through the pipe towards its distal end in the direction of arrow F.

The body 12 has two diametrically opposed side gas discharge openings 16. Each of these openings is formed by a U-shaped cut in the pipe wall. The resulting tab 18 is deformed outwardly to create a generally backward-facing nozzle.

The end cap 14 has a central bore 20, which leads to end discharge opening 22. A reduced-diameter plug portion 24 of the end cap 14 extends into the body 12 up to the position of the side discharge openings 16. Along the majority of the length of the plug portion 24 there exists a snug fit within the body 12, but the plug portion 24 tapers inwardly from the root region where tabs 18 are attached to the body 12, up to the tip 26 of the plug portion 24.

With this arrangement, the tip 26 of the plug portion 24 divides the axial flow of gas into a central stream 28 that flows through a central bore 20 and emerges from an end discharge opening 22, and two side streams 30 that emerge from the side discharge openings 16. The tapered portion of plug portion 24, combined with the tabs 18, serve as flow diverters that redirect the flow of side streams 30 such that each stream has a backward velocity component as it emerges from the side discharge opening 16. This arrangement causes a portion of each side gas discharge stream to flow backwards along the outside of the pipe as it enters the adjacent chamber of the airbag.

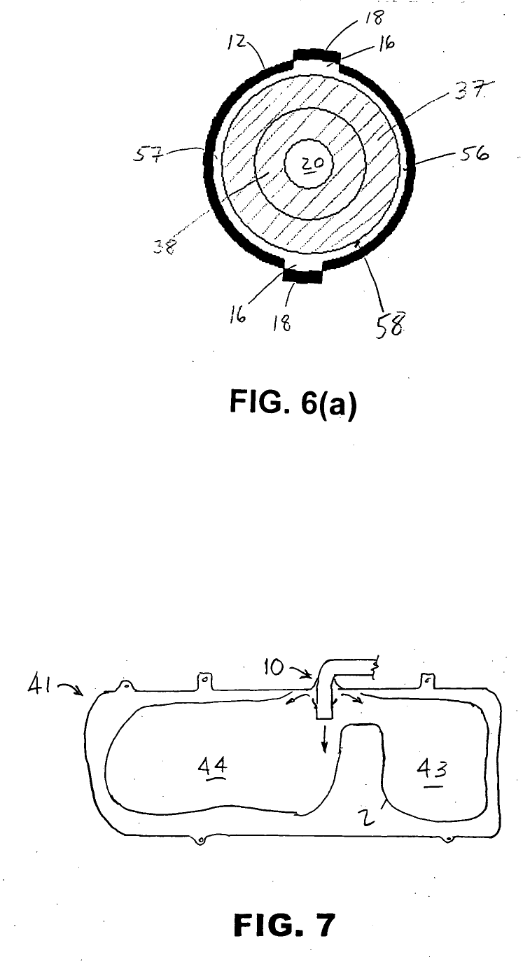

FIGS. 4 and 6 depict a gas distribution pipe 10 according to another embodiment of the invention. Reference numbers used in connection with the aforementioned embodiment are also used herein, and in FIG. 6, to denote substantially identical structure. Thus, a pipe 10 has a body 12 with two side discharge openings 16 formed by tabs 18, in the same manner as described above. The end cap 32 in this embodiment has a central bore 20, which leads to an end discharge opening 22. FIG. 6 discloses a differently configured plug portion 34 of the end cap.

The plug portion 34 is reduced substantially in diameter to create an annular space 35 between the plug portion 34 and the body 12. The plug portion has a wider head portion 37 that lies close to, but does not contact, the root region of tabs 18 (where they are attached to body 12) and tapers inwardly up to the tip 36 of the plug portion 34, where the plug portion 34 terminates in a blunt face 38.

The arrangement of FIG. 6, like that of FIG. 5, divides the axial flow of gas into a central stream 28 that flows through central bore 20 and emerges from the end discharge opening 22, and side streams, having a backward velocity component, that emerge from side discharge openings 16. Plug portion 34 actually divides the side flows into two components: streams 30 that emerge directly from side discharge openings 16 after passing head portion 37; and streams 40 that first detour through the annular space 35 that surrounds the plug portion 34.

Because the head portion 37 does not contact body 12, gas can flow past the head portion and into the annular space 35. FIG. 6(a) shows a cross-section view taken along line 7-7 in FIG. 6. Gas flow into the annular space 35 occurs in the two semi-annular regions 56 and 57 between the two side discharge openings 16. This flow is encouraged by the pressure drop in the root regions of the tabs 18 as gas streams 30 emerge directly from the openings 16, which tends to draw gas from the annular space 35 past the tab root regions (see arrows 40 in FIG. 6). Thus, the detoured flow 40 through the annular space 35 augments the direct flow streams 30.

The flow through the annular space 35, optionally, can be enhanced by enlarging the flow area in the semi-annular regions between the two side discharge openings 16, such as by notching (not shown) the periphery 58 of the head portion 37; or by providing additional flow paths into the annular space 35, such as by drilling (not shown) through the head portion 37.

The gas distribution pipe may be used in several different arrangements, such as the one depicted in FIG. 1. The gas distributed pipe of the invention can also be used to inflate a side curtain airbag from a point intermediate the length of the airbag. FIG. 7 depicts an example of this type of arrangement. In this example the gas distribution pipe 10 (such as, for example, either of the embodiments shown in FIGS. 5 and 6) enters airbag 41 in a downward direction. The arrows show the flow of inflation gas into the airbag chambers 43, 44, which are formed by stitching along sewing lines 2.

Given the broad disclosure of the present invention, one versed in the art would appreciate that there are other embodiments and modifications within the scope of the invention. Accordingly, all modifications attainable by one versed in the art from the present disclosure are to be considered as further embodiments of the present invention.

What is claimed is:

1. A safety system comprising:
an airbag including a plurality of inflatable cells;
a gas distribution pipe located in the airbag and including an end discharge opening and a side discharge opening;
wherein the distribution pipe includes a deflecting mechanism for directing a portion of the inflation gas away from the end discharge opening and toward the side discharge opening so that the cells inflate in a balanced manner.

2. The system of claim 1, further comprising a plurality of side discharge openings distributed along the length of the pipe.

3. The system of claim 1, further comprising a plurality of side discharge openings distributed radially around the circumference of the pipe.

4. A side curtain airbag device comprising a gas distribution pipe having an end discharge opening and at least one side discharge opening, the side discharge opening having associated therewith a deflector that directs at least a portion of the gas exiting the side discharge opening generally backwards along the outside of the pipe

5. The device of claim 4, wherein the pipe includes a plurality of circumferentially spaced side discharge openings at one lengthwise position on the pipe.

6. The device of claim 5, wherein two of the side discharge openings are diametrically opposed.

7. The device of claim 4, further comprising an internal flow divider that divides a portion of the gas from the main axial flow and diverts it toward the side discharge opening.

8. The device of claim 5, wherein the flow divider diverts gas to all of the side discharge openings located at one lengthwise position along the pipe.

9. The device of claim 7, wherein the flow divider is part of an end cap for the pipe.

10. The device of claim 9, wherein the end discharge opening is formed in the end cap and the flow divider extends into the pipe up to the lengthwise position of the side discharge opening.

11. A method of deploying a side curtain airbag comprising the steps of:
introducing inflation gas into one airbag chamber through a discharge opening at the end of a gas distribution pipe, and
introducing inflation gas to an upstream airbag chamber through at least one side discharge opening such that at least a portion of the gas that emerges from the side discharge opening flows generally backwards along the outside of the pipe toward an entrance of the upstream airbag chamber.
